(19) United States
(12) Patent Application Publication
(10) Pub. No.: US 2009/0208100 A1
(43) Pub. Date: Aug. 20, 2009

(54) Website color match system

(76) Inventor: Morris Bendah, San Ramon, CA (US)

Correspondence Address: MORRIS BENDAH, 2750 Merced Street, San Leandro, CA, 94577, US

(21) Appl. No.: 12/322,713

(22) Filed: Feb. 4, 2009

Related U.S. Application Data
(60) Provisional application No. 61/026,066, filed on Feb. 4, 2008.

(51) Int. Cl. G06K 9/00; G09G 5/02

(52) U.S. Cl. 382/167; 345/589

(57) ABSTRACT

The present invention includes a colored appliance, which could be in the form of a standard color wheel in the form of a collapsible keychain or mailer. which is placed on or next to the colored item being photographed and used in a system to standardize the colors seen by a viewer. The consumer is sent a brochure with a color wheel or told to look at a standard overnight envelope like that of Fedex™ or USPS™. When looking at the digital photograph on the business's web site, the consumer would be able to instantly make adjustments to the colors on his computer monitor to see colors accurately by comparing the color wheel on the monitor to the overnight envelope's printed color or to a preferred standard color wheel.

### RELATED APPLICATIONS

The present application is a continuation-in-part application of U. S. provisional patent application, Ser. No. 61/026,066, filed Feb. 4, 2008, included by reference herein and for which benefit of the priority date is hereby claimed.

### FIELD OF THE INVENTION

The present invention relates to a color matching system for websites and, more particularly, to a colorwheel and website publishing method whereby consumers looking at the published website can adjust colors on their computer monitor to see the same colors that the website author intended.

### BACKGROUND OF THE INVENTION

Presently, when consumers are looking at color pictures on web sites, they have no idea if the color they are seeing on the computer monitor is the color in real life, as the author intended. This is because computer monitors can skew to pink or green to different degrees and therefore not show the color intended. Also the picture being shown was taken by a camera in certain light conditions which can change the way the colors are presented in a digital image. Presently, if a consumer wants to confirm a color, they would need to get a physical sample or catalog sent to them in real life by mail or parcel service. For example, it may be necessary to ship consumers heavy granite samples, to confirm color representations. This is expensive and time consuming.

Some expensive electronic solutions exist within printing and graphic design companies to standardize colors. These expensive systems include specialized standardized equipment that is self correcting or physical attachments to monitors that use software to correct color automatically. The most widely used solution now is to ignore the monitor image and send catalogues or physical samples of the items for customer confirmation.

Specialized standardized equipment that is self correcting or physical attachments to monitors that use software to correct color automatically are not feasible solutions for everyday consumers or the many businesses that service them. Part of the economization of business by the Internet was the avoidance of using snail mail techniques where possible. Productivity is increased when less money is spent to do the same business using less paper, time and expense. Since there are a huge variety of computers in the marketplace and also a large variety of monitors, it is impossible to standardize them without replacing them all. This would be an unfeasible and cost-ineffective solution. Sending a customer a catalogue is not always feasible. The item could change colors from time to time so that the catalogue would have to be mailed repeatedly. This is exactly the case with natural articles like wood or stone, where every time it is manufactured, the raw material may be slightly different in shade and tone. Samples are also not a solution much of the time. Sending a customer a small sample of a stone slab, for example, does not give them an idea of the color of the remainder of the slab. The same with a wooden chair or art like an oil painting. It is not possible to send a large enough sample to convey all the information.

### SUMMARY OF THE INVENTION

In accordance with the present invention, there is provided a colored appliance, which could be in the form of a color wheel, which is placed on or next to the colored item being photographed. The color wheel must not be shiny so that glare is not produced when it is photographed. The radial lines of a color wheel are also easier for a digital camera to focus on automatically (some cameras cannot focus on parallel lines easily). Also the round features of a color wheel make it easier for smart cameras to focus since it is similar in shape to a persons face. A digital image is produced with the color wheel and the item in the same picture. The item photographed could be a piece of colored granite, painted wood furniture or any other colored consumer item. The color wheel could be one published by the web site owner with known color separations as long as the same wheel was in the photograph as customers would have. Alternatively, the color wheel could contain colors that are well known and readily available such as the standard colors of new overnight mailers by Fedex™ or the US Postal Service. This would eliminate the need to send the customer a color wheel but the colors are more limited. These companies specify that their colors should be printed a certain hue, making them reasonably accurate. The consumer is sent a brochure with a color wheel or told to look at a standard mailer like that of Fedex™ or USPS™. When looking at the digital photograph on the business's web site, the consumer would be able to instantly make adjustments to the colors on his computer monitor to see colors accurately by comparing the color wheel on the monitor to the overnight envelope's printed color or to a standard color wheel. The standard color wheel is the best comparison and these could be available at many retailers inexpensively. The web site publisher would then notify his customers on the web page where photographs are shown that a color match appliance system was being used and web images of the color match appliance would be displayed.

It is therefore an object of the invention to provide a colored appliance that may be easily photographed.

It is another object of the invention to provide a color match appliance that may be circular.

It is another object of the invention to provide a color match appliance in which the colors are not shiny.

It is another object of the invention to provide a color match appliance that can focused on by a digital camera.

It is another object of the invention to provide a color match appliance with the standard colors used by national overnight shippers.

It is another object of the invention to provide a standard color match appliance with standard colors that can be reproduced exactly.

It is another object of the invention to provide a color match appliance that can be attached to many different surfaces temporarily.

It is another object of the invention to provide a color match appliance reproduction that can be mailed in an envelope.

It is another object of the invention to provide a color match appliance reproduction that can be shielded from light so that it doesnt fade.

It is another object of the invention to provide a notification to a viewer of the web site that this color match appliance is being used.

It is another object of the invention to provide a web image on a website of a color match appliance so that it could be compared to one in hand

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a digital camera taking a picture of a colored item with a color match appliance attached to it;

FIG. 2 is a perspective view of a person looking at a picture of a colored item and color match appliance on a computer monitor and comparing it to a color match appliance in his hand;

FIG. 3 is a front detail view of a color match appliance and perspective, collapsed and back view of the collapsible color match appliance; and

FIG. 4 is a front view of a customer color match appliance mailer and a collapsible perspective view of customer color match appliance keychain.

For purposes of clarity and brevity, like elements and components will bear the same designations and numbering, throughout the Figures.

### DESCRIPTION OF THE PREFERRED EMBODIMENT

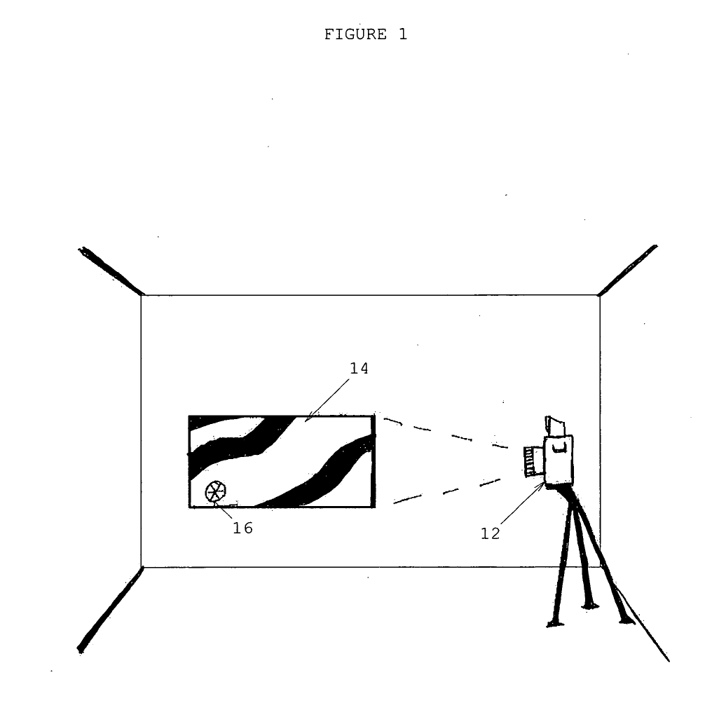

FIG. 1 is a perspective view of an a digital camera 12 taking a picture of a colored object 14 with a Collapsible Color Match Appliance 10 or Color Match Appliance 16 attached to it.

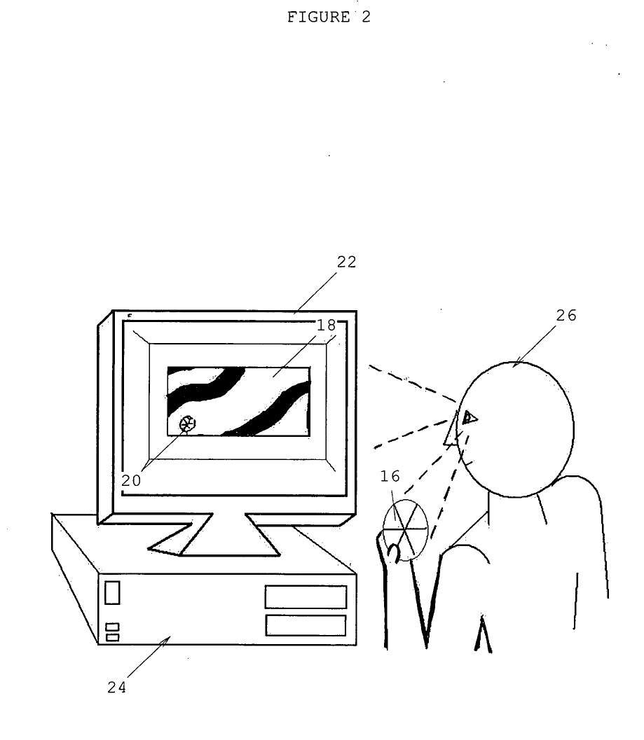

FIG. 2 is a perspective view of a person 26 looking at a web image of colored object 18 with Web Image of color match appliance 20 on a computer monitor 22 which is attached to a computer CPU 24. The person 26 compares the Web Image of color match appliance 20 with a color match appliance 16 in his hand.

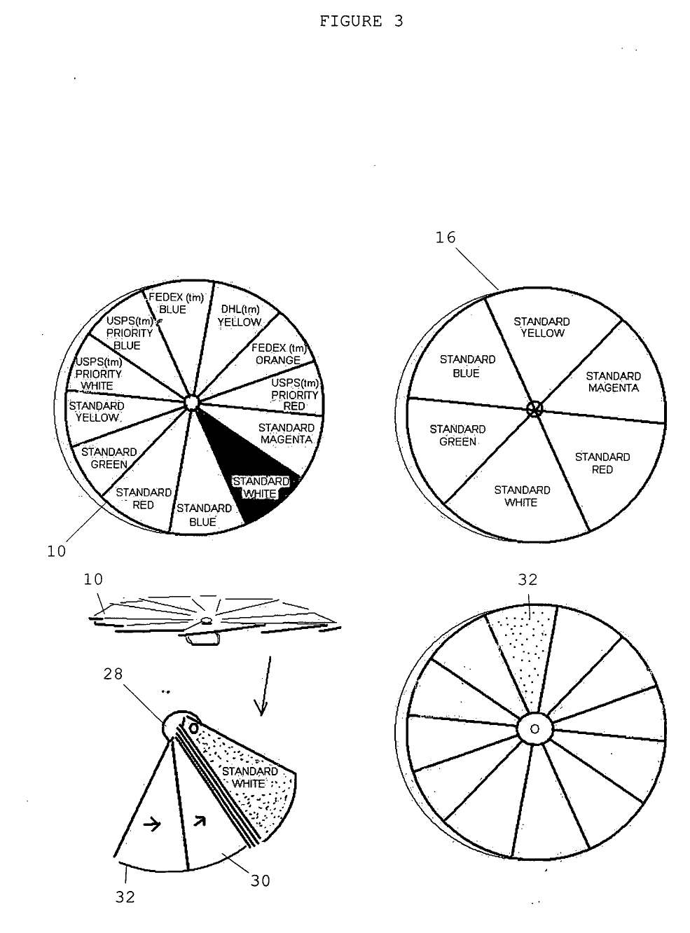

FIG. 3 is a front detailed view of a color match appliance 16 and perspective, collapsed and back view of the Collapsible Color Match Appliance 10 showing connected color segments 30, first standard white segment 34, last velcro backed segment 32 and attached optional keychain loop 28.

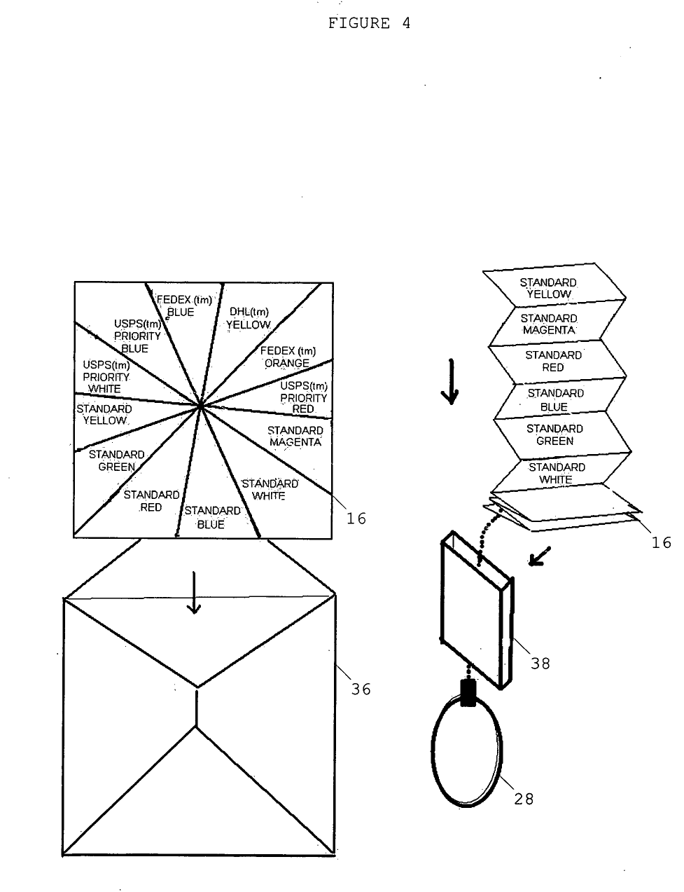

FIG. 4 is a front view of a customer color match appliance 16 mailer that fits in an envelope 36 and a collapsible perspective view of customer foldable color match appliance 16 in a compact holder 38 and attached keychain loop 28

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A website color match system for ensuring that colors published on a website can be seen by customers as the author intended, comprising:
means for opening and then attaching or putting next to item being digitally photographed so that digital published image can be compared to another identically colored color match appliance;
means for attaching or putting next to item being digitally photographed so that digital published image can be compared to another identically colored color match appliance;
means for showing on the web site and comparing to color match appliance in hand so that colors on the computer monitor can be adjusted correctly;
means for connecting together to form a color match appliance that can be used to compare web images of colors to their actual colors, visually encompassing to said means for opening and then attaching or putting next to item being digitally photographed so that digital published image can be compared to another identically colored color match appliance; and
means for covering and protecting foldable color match appliance in a compact manner that can be attached to keychain loop.

2. The website color match system in accordance with claim 1, wherein said means for opening and then attaching or putting next to item being digitally photographed so that digital published image can be compared to another identically colored color match appliance comprises an unshiny, segments have different standard colors, circular when opened, segmented, back of final segment has velcro, first segment is unfadable white color, central rivet holds all segments together, collapsible so it is compact, may have keyring for for attaching to other object collapsible color match appliance.

3. The website color match system in accordance with claim 1, wherein said means for attaching or putting next to item being digitally photographed so that digital published image can be compared to another identically colored color match appliance comprises a standard color segments or well known color segments, velcro backed for attachment, unshiny, circular or rectangular shaped color match appliance.

4. The website color match system in accordance with claim 1, wherein said means for showing on the web site and comparing to color match appliance in hand so that colors on the computer monitor can be adjusted correctly comprises a showing standard colors, published on a web site web image of color match appliance.

5. The website color match system in accordance with claim 1, wherein said means for connecting together to form a color match appliance that can be used to compare web images of colors to their actual colors comprises a standard colors chosen by publisher, well known colors, unshiny color segments.

6. The website color match system in accordance with claim 1, wherein said means for covering and protecting foldable color match appliance in a compact manner that can be attached to keychain loop comprises a rectangular, attaches to keychain loop compact holder.

7. A website color match system for ensuring that colors published on a website can be seen by customers as the author intended, comprising:
an unshiny, segments have different standard colors, circular when opened, segmented, back of final segment has velcro, first segment is unfadable white color, central rivet holds all segments together, collapsible so it is compact, may have keyring for attaching to other object collapsible color match appliance, for opening and then attaching or putting next to item being digitally photographed so that digital published image can be compared to another identically colored color match appliance;
a standard color segments or well known color segments, velcro backed for attachment, unshiny, circular or rectangular shaped color match appliance, for attaching or putting next to item being digitally photographed so that digital published image can be compared to another identically colored color match appliance;
a showing standard colors, published on a web site web image of color match appliance, for showing on the web site and comparing to color match appliance in hand so that colors on the computer monitor can be adjusted correctly;
a standard colors chosen by publisher, well known colors, unshiny color segments, for connecting together to form a color match appliance that can be used to compare web images of colors to their actual colors, visually encompassing to said Collapsible Color Match Appliance; and
a rectangular, attaches to keychain loop compact holder, for covering and protecting foldable color match appliance in a compact manner that can be attached to keychain loop.

8. The website color match system as recited in claim 7, further comprising:
a circular keychain loop, for attaching to keychains or other objects, rotatably coupled to said color segments.

9. The website color match system as recited in claim 7, further comprising:
a last segment velcro backed segment, for temporarily attaching to velcro on colored object, permanently riveted to said color segments.

10. The website color match system as recited in claim 7, further comprising:
a first segment, non-fading standard white segment, for covering the collapsible color match appliance, when collapsed, so other colors do not fade, permanently riveted to said color segments.

11. The website color match system as recited in claim 8, further comprising:
a last segment velcro backed segment, for temporarily attaching to velcro on colored object, permanently riveted to said color segments.

12. The website color match system as recited in claim 8, further comprising:
a first segment, non-fading standard white segment, for covering the collapsible color match appliance, when collapsed, so other colors do not fade, permanently riveted to said color segments.

13. The website color match system as recited in claim 9, further comprising:
a first segment, non-fading standard white segment, for covering the collapsible color match appliance, when collapsed, so other colors do not fade, permanently riveted to said color segments.

14. The website color match system as recited in claim 11, further comprising:
a first segment, non-fading standard white segment, for covering the collapsible color match appliance, when collapsed, so other colors do not fade, permanently riveted to said color segments.

15. A website color match system for ensuring that colors published on a website can be seen by customers as the author intended, comprising:
an unshiny, segments have different standard colors, circular when opened, segmented, back of final segment has velcro, first segment is unfadable white color, central rivet holds all segments together, collapsible so it is compact, may have keyring for attaching to other object collapsible color match appliance, for opening and then attaching or putting next to item being digitally photographed so that digital published image can be compared to another identically colored color match appliance;
a standard color segments or well known color segments, velcro backed for attachment, unshiny, circular or rectangular shaped color match appliance, for attaching or putting next to item being digitally photographed so that digital published image can be compared to another identically colored color match appliance;
a showing standard colors, published on a web site web image of color match appliance, for showing on the web site and comparing to color match appliance in hand so that colors on the computer monitor can be adjusted correctly;
a circular keychain loop, for attaching to keychains or other objects;
a standard colors chosen by publisher, well known colors, unshiny color segments, for connecting together to form a color match appliance that can be used to compare web images of colors to their actual colors, rotatably coupled to said Keychain loop, and visually encompassing to said Collapsible Color Match Appliance;
a last segment velcro backed segment, for temporarily attaching to velcro on colored object, permanently riveted to said color segments;
a first segment, non-fading standard white segment, for covering the collapsible color match appliance, when collapsed, so other colors do not fade, permanently riveted to said color segments; and
a rectangular, attaches to keychain loop compact holder, for covering and protecting foldable color match appliance in a compact manner that can be attached to keychain loop.
